(19) United States
(12) Patent Application Publication
(10) Pub. No.: US 2025/0363442 A1
(43) Pub. Date: Nov. 27, 2025

(54) Intelligent Bundling of Items From a Live Platform

(71) Applicant: WHATNOT INC., Marina Del Rey, CA (US)

(72) Inventors: Aidan Church, San Francisco, CA (US); Sunpreet Randhawa, Los Angeles, CA (US); Amish Kagalwala, San Carlos, CA (US)

(21) Appl. No.: 18/674,485

(22) Filed: May 24, 2024

(51) Int. Cl. G06Q 10/083

(52) U.S. Cl. CPC G06Q 10/083

(57) ABSTRACT

Systems and methods track distribution of items in a “live event,” e.g., where items are successively offered by a host in conjunction with a live video stream from the host to guests. Upon conclusion of a live event, systems and methods identify sets of items intended for respective recipients, and use “intelligent bundling” techniques to determine particular combinations of items to be shipped together, e.g., based upon item information and shipping cost information of one or more carriers. Upon application of the intelligent bundling techniques, further functionalities may be provided to facilitate distribution of items from the host to respective recipients.

### TECHNICAL FIELD

The present disclosure generally relates to communications and interactions in a mobile computing platform, and more specifically, to systems and methods for tracking distribution of items through a live event to facilitate shipping of items to respective recipients.

### BACKGROUND OF THE DISCLOSURE

Technological improvements to mobile computing devices, such as smartphones, smart tablets, and the like, have offered opportunities to make various interactive electronic services available via mobile computing devices, where previously such services might have only been available at most via desktop and/or laptop computers. Such electronic services have included, for example, auctions of consumer goods, including collectible items such as trading cards, toys, figurines, comic books, video games etc.

In particular, an existing platform available on mobile computing devices and other devices enables a seller (or “host”) to offer one, two, three, four or more items via a live event (e.g., in the form of auctions and/or direct purchase offers). In the live event, the host's device records a real-time video/audio stream, which prospective bidders or “guests” view at their own devices in conjunction with a graphical user interface (GUI) that enables the guests to send and receive communications regarding the offers (e.g., auction bids, comments, updates to items, etc.) substantially in real-time. The host can use their transmitted video stream to, for example, visually feature a currently offered item and/or other items in the host's collection. Guests can participate in the live event, for example, to bid on or purchase one, two, three, four or more items, to engage with the host and/or other guests via comments and/or other features, or to just watch the live video stream passively. At least these aspects of live events provide substantial benefits over conventional systems for online auctions and other online commerce systems, for example by enabling hosts and guests to send and receive updated information substantially in real-time without the devices having to reload or refresh the GUI by which the devices participate in the live event, thus providing uninterrupted, social access to the live event. Further description, including system implementation details for live events, is provided in U.S. Pat. No. 11,196,577, filed Apr. 22, 2021, which is hereby incorporated by reference herein in its entirety.

In many traditional implementations of online selling platforms, the seller (or, in some cases, a shipping/fulfillment center) is responsible for shipping sold items to respective recipients upon closing of sales. Such shipping processes typically involve obtaining shipping labels that identify the recipients (e.g., mailing addresses based upon stored user profile information), and applying the shipping labels to packages to be sent via a carrier (e.g., United States Postal Service® (USPS®)). In some possible implementations, each sold item individually is provided its own shipping label and package. In other possible implementations, where a same recipient is to receive two, three, four, or more items, the multiple items are combined into a single package under one shipping label, with the aim of reducing complexity of packaging and/or reducing carrier fees associated with shipping. The present disclosure identifies, though, that traditional techniques in converting online selling platform activities to shipments do not effectively account for costs incurred based upon items sold throughout a live event, and the size, weights, and/or other properties of each item.

### SUMMARY

The present disclosure, at a high level, provides intelligent (or “smart”) item bundling functionalities in the context of a live event. Particularly, techniques of the present disclosure include tracking distribution of items throughout a live event to identify respective items awarded to respective recipients over the course of a live event (e.g., auctioned, raffled, or otherwise awarded to a recipient). Upon conclusion of a live event, a plurality of items are identified as being awarded to a same recipient. Based upon item information and item shipping profile information associated with each of the plurality of identified items, an intelligent (“smart”) bundling system determines a most cost-efficient structure for shipping the plurality of identified items to the recipient via a selected carrier (e.g., USPS®). The intelligently determined shipping structure may for example include any given item shipped individually, or any two or more items grouped or (“bundled”) together under same shipping label. Shipping labels may be generated and items facilitated to the recipient accordingly. In various embodiments, item sellers can define further restrictions on how bundles comprising their items are to be determined, e.g., by defining which items can be shipped with which other items offered by the seller.

In embodiments, a computer-implemented method is provided. The computer-implemented method may include (1) monitoring a plurality of electronic communications in a live event associated with (i) respective offerings of a plurality of items by a host to a plurality of guests via a publish/subscribe messaging framework among a client computing device of the host and respective client computing devices of the plurality of guests, and (ii) a real-time video stream from the client computing device of the host to each of the respective client computing devices of the plurality of guests, the real-time video stream persisting through the offerings of items, wherein the monitoring comprises identifying indications of assignments of respective ones of the plurality of items to respective recipients from among the plurality of guests, (2) causing the indications of the assignments of the respective ones of the plurality of items to be provided as inputs to an intelligent bundling means at one or more servers or at the client computing device of the host, (3) via the intelligent bundling means, (i) identifying, from among the plurality of items, a subset of items comprising two or more items assigned to a particular recipient, based upon the monitored electronic communications, and (ii) determining a shipping schema for providing the subset of items from an origin to a location of the particular recipient, based upon (i) item information associated with respective ones of the subset of items, and (ii) shipping information associated with a carrier, wherein the determined shipping schema comprises a bundled shipment of multiple items from among the subset of items, and wherein the determined shipping schema minimizes a total shipping cost of the subset of items from the origin to the location of the particular recipient in view of the shipping information associated with the carrier, and/or (4) causing an indication of the determined shipping schema to be presented to the host via the client computing device of the host. The computer-implemented method may include additional, fewer, and/or alternate actions, in various embodiments.

In embodiments, one or more non-transitory computer readable media are provided. The one or more non-transitory computer readable media may store non-transitory computer executable instructions that, when executed via one or more processors of one or more computers, cause the one or more computers to (1) monitor a plurality of electronic communications in a live event associated with (i) respective offerings of a plurality of items by a host to a plurality of guests via a publish/subscribe messaging framework among a client computing device of the host and respective client computing devices of the plurality of guests, and (ii) a real-time video stream from the client computing device of the host to each of the respective client computing devices of the plurality of guests, the real-time video stream persisting through the offerings of items, wherein the monitoring comprises identifying indications of assignments of respective ones of the plurality of items to respective recipients from among the plurality of guests, (2) cause the indications of the assignments of the respective ones of the plurality of items to be provided as inputs to an intelligent bundling means at one or more servers or at the client computing device of the host, (3) via the intelligent bundling means, (i) identify, from among the plurality of items, a subset of items comprising two or more items assigned to a particular recipient, based upon the monitored electronic communications, and (ii) determine a shipping schema for providing the subset of items from an origin to a location of the particular recipient, based upon (i) item information associated with respective ones of the subset of items, and (ii) shipping information associated with a carrier, wherein the determined shipping schema comprises a bundled shipment of multiple items from among the subset of items, and wherein the determined shipping schema minimizes a total shipping cost of the subset of items from the origin to the location of the particular recipient in view of the shipping information associated with the carrier, and/or (4) cause an indication of the determined shipping schema to be presented to the host via the client computing device of the host. The one or more non-transitory computer readable media may include additional, fewer, and/or alternate instructions, in various embodiments.

In still other embodiments, a computing system is provided. The computing system may include one or more processors and one or more memories storing non-transitory computer executable instructions. The instructions, when executed via the one or more processors, may cause the computing system to (1) monitor a plurality of electronic communications in a live event associated with (i) respective offerings of a plurality of items by a host to a plurality of guests via a publish/subscribe messaging framework among a client computing device of the host and respective client computing devices of the plurality of guests, and (ii) a real-time video stream from the client computing device of the host to each of the respective client computing devices of the plurality of guests, the real-time video stream persisting through the offerings of items, wherein the monitoring comprises identifying indications of assignments of respective ones of the plurality of items to respective recipients from among the plurality of guests, (2) cause the indications of the assignments of the respective ones of the plurality of items to be provided as inputs to an intelligent bundling means at one or more servers or at the client computing device of the host, (3) via the intelligent bundling means, (i) identify, from among the plurality of items, a subset of items comprising two or more items assigned to a particular recipient, based upon the monitored electronic communications, and (ii) determine a shipping schema for providing the subset of items from an origin to a location of the particular recipient, based upon (i) item information associated with respective ones of the subset of items, and (ii) shipping information associated with a carrier, wherein the determined shipping schema comprises a bundled shipment of multiple items from among the subset of items, and wherein the determined shipping schema minimizes a total shipping cost of the subset of items from the origin to the location of the particular recipient in view of the shipping information associated with the carrier, and/or (4) cause an indication of the determined shipping schema to be presented to the host via the client computing device of the host. The computing system may be configured to perform additional, fewer, and/or alternate actions, in various embodiments.

### BRIEF DESCRIPTION OF THE FIGURES

FIG. 1 is a block diagram of an example computing environment, in accordance with some embodiments of the present description;

FIG. 2 depicts a chart of shipping costs of an example carrier service, in accordance with some embodiments;

FIG. 3 depicts a chart of example item shipping weights, in accordance with some embodiments;

FIG. 4A depicts an example graphical user interface (GUI) associated with a saved shipping profile, in accordance with some embodiments;

FIG. 4B depicts an example GUI associated with defining a custom shipping profile, in accordance with some embodiments;

FIG. 4C depicts another example GUI associated with defining a custom shipping profile, in accordance with some embodiments;

FIG. 5 depicts another example GUI associated with presenting bundled shipments to a host, in accordance with some embodiments;

FIG. 6 is a block diagram of an example client computing device and server, in accordance with some embodiments; and

FIG. 7 is a flow diagram of an example method implemented via one or more computers, in accordance with some embodiments.

### DETAILED DESCRIPTION

Embodiments of the present description relate to computing systems and methods that, broadly speaking, provide intelligent (or “smart”) bundling of items offered in a live event (“item sales,” e.g., items offered for direct purchase, auctions, giveaways/raffles, etc.).

In traditional implementations of online selling platforms, the seller is responsible for shipping sold items to respective recipients (i.e., the guests in the live event who perform a direct purchase of the items, win an auction for the items, win a giveaway of the items, etc.). Alternatively, a shipping/fulfillment center may be involved in the shipping process, e.g., receiving the items from the seller before or after the item sales and distributing the items to recipients once sales are completed. Shipping involves generating shipping labels that identify the buyers (e.g., mailing addresses based upon stored user profile information), and applying the shipping labels to packages to be sent via a carrier (e.g., United States Postal Service® (USPS®)). In many implementations, the online selling platform itself generates the shipping labels, e.g., for the seller to print and affix to respective packages.

In any case, a shipping cost from the carrier (or “carrier fee”) is incurred when an item is sent to the recipient via the carrier (e.g., United States Postal Service® (USPS®)). Various online selling platforms might choose to place the shipping cost upon the seller, the recipient, and/or the online platform itself, but the shipping cost is incurred in any case, and generally increases when a plurality of items require shipping to a particular recipient. Some online selling platforms might choose to approach shipping of multiple items to a same recipient by providing each individual item its own shipping label (and hence, its own package). In other online commerce implementations, where a person is to receive two, three, or four items, the multiple items are packaged together under one shipping label, ostensibly to reduce carrier fees and/or complexity of packaging. The present disclosure observes that, even in implementations that do combine (or “bundle”) multiple items together in one package, existing online selling platforms do not fully account for the precise cost structures imposed by the carrier in determining whether to bundle items. For example, the existing platforms do not fully consider whether bundling actually reduces total carrier fees in a given case, e.g., based upon the weights and sizes of the packaged items.

In view of these shortcomings of existing online selling platforms, the present disclosure provides systems and methods by which groups of items directed to recipients are intelligently bundled for shipping in view of applicable carrier fees, to substantially reduce the costs incurred by the seller (e.g., host of a live event), recipient (e.g., guest in the live event), and/or platform.

More particularly, techniques of the present disclosure include monitoring electronic communications in a live event, at least in part by identifying indications of which items have been awarded to which recipient, for example upon the conclusion of each direct purchase offer, auction, or giveaway in the live event. Techniques herein further include identifying a plurality of items as having been awarded to a same recipient. An intelligent bundling (or “smart bundling™”) system determines a most cost-efficient structure for shipping the identified plurality of items based for example upon (1) fee structures of the carrier, for example as a function of weight and/or size (e.g., dimension in any axis, and/or total volumetric size)), (2) the identities, weights, and sizes of the respective items to be shipped, and/or (3) further bundling/shipping constraints defined by the host, recipient, platform, and/or carrier. Determinations by the intelligent bundling system, for example, include a particular plurality of items together under one shipping label and package, shipping a particular item(s) individually, or some combination thereof as will be evident from this disclosure. In embodiments, shipping labels are generated and/or provided to the host (or to a fulfillment center) accordingly.

Additionally, in some embodiments, a host may define “custom shipping profiles” characterizing the item types, shipping weights/sizes, and/or other constraints for any particular item(s) offered by the host, so as to affect the manner in which the intelligent bundling system assigns bundles for the items when offered by the host. For example, a host may define a base shipping weight of the item and/or packaging when a first of a given item is shipped, an incremental shipping weight added when a second of the item is bundled with the first of the item, and/or a maximum number of the item that is permitted to be bundled together and/or bundled with other items under a same shipping label/package.

### Example Computing Environment

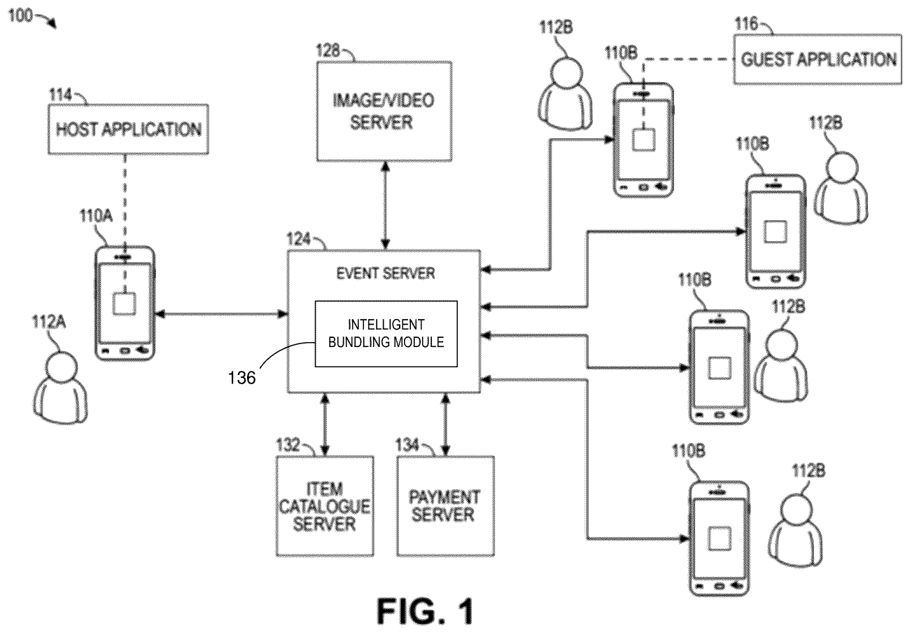

FIG. 1 depicts a block diagram of an example computing environment 100 via which techniques of the present description may be implemented. In particular, elements of the computing environment 100 may implement live events (e.g., including one or more live auctions, offers for direct purchase, and/or giveaways) and facilitate shipping of items thereafter, e.g., via the intelligent bundling techniques of the present disclosure. Although various components of the example computing environment 100 will be described below, it should be understood that additional, fewer, and/or alternate components may be envisioned in various embodiments, without necessarily deviating from the techniques described herein.

The computing environment includes a first client computing device 110a (e.g., mobile device) associated with a first user 112a, and a plurality of second client computing devices 110b associated with respective ones of a plurality of second users 112b. Client computing devices 110a and 110b may include, for example, smartphones, smart tablets, smart wearable devices, other suitable mobile devices, desktop computers and/or other non-mobile devices, or some combination thereof.

In the example computing environment 100, the first user 112a represents a “host” or “seller” in a live event described herein, e.g., a person or entity making one or more items available for auction, direct purchase, and/or giveaway via the live event technology described herein. Accordingly, the first client computing device 110a is generally referred to herein as a host device 110a. The second users 112b in this example represent prospective item buyers/recipients (or simply “guests”) who access the live event via the systems/methods described herein to view items, bid on or purchase items, and/or perform various other actions described herein. Accordingly, the client computing devices 110b are referred to herein as guest devices 110b.

Each of the client computing devices 110a and 110b may respectively comprise one or more computer processors and one or more non-transitory computer memories storing instructions that, when executed via the one or more processors, cause the device 110a or 110b to perform the actions attributed to the device 110a or 110b in the present description. In the case of the host device 110a, the one or more non-transitory memories may store one or more software applications 114 (“host application”) including one or more sets of non-transitory computer executable instructions that, when executed via the one or more processors, cause the host device 110a to perform actions described herein. Similarly, the one or more memories of each guest device 110b may store one or more software applications 116 (“guest application”) including one or more sets of non-transitory computer executable instructions that, when executed via the one or more processors of the guest device 110b, cause the guest device 110b to perform actions described herein. Although host application 114 and guest application 116 are depicted as separate blocks in FIG. 1, it should be understood that applications 114 and 116 may represent separate aspects of the same one or more applications (e.g., a single application stored and executed both at host device(s) 110a and guest device(s) 110b, in which each user 112a or 112b may alternatively operate as a host or guest using the single application). Each of the host device 110a and guest devices 110b may comprise one or more application programming interfaces (APIs) operable for example to (1) generate and display GUIs, (2) capture or otherwise obtain still images and/or videos, (3) display images, videos, item information, and/or other information described herein, (4) communicate with one or more servers (e.g., to receive real-time item information and/or communicate bids/purchases placed via the each device, to exchange information associated with shipping and intelligent bundling of items, etc.), and/or perform other actions described herein.

The host device 110a (and, in some instances, the guest devices 110b) may comprise one or more camera devices, which may for example capture a real-time video stream for a live event. Additionally, in some embodiments, the host device 110a (and in some instances, the guest devices 110b) includes one or more microphones and/or speaker, which may capture, transmit, and/or play audio (e.g., accompanying audio in a video stream). The one or more camera devices, microphones, and/or speakers may include integrated devices (e.g., a camera, microphone, or speaker natively included in a client computing device) and/or devices otherwise communicatively tethered to the host device 110a or guest device 110b (e.g., a peripheral webcam, speaker, or microphone connected wiredly or wirelessly to the client computing device). Additionally, each of the host device 110a and guest devices 110b may include one or more interactive I/O units (e.g., touchscreens, touchpads, keyboard, etc.) enabling navigation of GUIs, viewing of images and/or videos in the context of a real-time video stream, and/or interactive functionalities described herein.

An event server 124 (i.e., one or more servers) may facilitate communications among devices 110a and 110b, and may store various information associated with implementation of the live events as described herein. For example, the event server 124 may store and distribute information relating to items and/or item queues, and/or implement logic relating to offerings of items via auction, direct purchase, and/or giveaway. Additionally or alternatively, the event server 124 may store and/or distribute still other information such as user profile information, user device configuration information, live event metrics and analytics, etc. The event server 124 may include one or more processors and one or more non-transitory computer readable memories storing instructions that, when executed via the one or more processors, cause the event server 124 to perform the actions described herein.

More particular, in envisioned embodiments, the event server 124 implements a messaging framework referred to as a “publish/subscribe channel.” In a publish/subscribe channel, a message broker (e.g., the event server 124) is configured to operate as a central hub for messaging among each of a plurality of devices “registered” as participants in the channel (e.g., the host device(s) 110a) and guest devices 110b). At a high level, the message broker accesses or maintains a registry indicating a list of registered participants and the particular types “classes” of messages the participants are registered to send (“publish”) to the message broker and/or automatically receive (“subscribe to”) from the message broker in the publish/subscribe channel. For any first participant to distribute a given message to one or more other registered participants, the first participant sends or “publishes” a message to the message broker. Rather than the published message explicitly identifying one or more intended recipients, the message broker in the publish/subscribe framework identifies the class of the message and uses the message class (and, in some instances, the payload of the message) to determine which other one(s) of the registered participants are subscribed to receive the published message. Responsive to this determination, the message broker automatically transmits (or “broadcasts”) the message to the other identified participant device(s) in real-time. Thus, a publisher of a given message in the publish/subscribe channel does not directly program the message to be sent to specific recipients, but rather, categorizes the message as belonging to a particular class, based upon which the message broker identifies the proper recipient(s). Conversely, subscribers express interest in receiving particular classes of messages automatically from the message broker, but are not specifically aware of what publishers exist at any given time, and do not explicitly request the messages broadcasted by the message broker (e.g., by needing to submit an HTTP request to obtain information). As a result, in the publish/subscribe framework, publisher and subscriber devices do not need to be specifically aware of each other or directly connected to each other, and instead connect only to the message broker, making the publish/subscribe framework a scalable solution for facilitating real-time communications among potentially many participant devices. Further description of implementation of the publish/subscribe messaging framework and the technical advantages thereof can be found in U.S. Pat. No. 11,196,577, filed Apr. 22, 2021.

In view of the above communications in a live event may particularly include publish/subscribe messages generated and/or transmitted via the host device 110a, event server 124, and/or any guest device 110b. Particular ones of the monitored communications may directly or indirectly identify which respective ones of a plurality of items offered in a live event have been awarded to which respective recipients. For example, a message generated and/or transmitted by the event server 124 may indicate or acknowledge that a specific guest 112b has successfully performed a direct purchase or won an auction. As another example, even lacking a particular electronic communication indicating which specific guest 112b won an auction, the event server 124 upon conclusion of an auction may reference past communications indicating the final bid successfully placed prior to the auction's conclusion, which would correspond to the highest bid and thus the winner of the auction (thereby indirectly indicating an item awarded to a particular recipient). In some embodiments, outputs of the intelligent bundling techniques described herein may be distributed to the host device 110a and/or guest devices 110b by way of publish/subscribe messages by way of the event server 124.

The event server 124 may communicate with still additional servers to facilitate other functions described herein. For example, an image/video server 128 may facilitate operations of the event server 124 by facilitating provision of the real-time video stream from the host device 110a to the guest devices 110b (e.g., the host device 110a may provide the real-time video to the image/video server 128, which in turn may stream the image/video to the guest devices 110b without the host device 110a needing to be explicitly aware of each of the guest devices 110b). This real-time video stream may persist throughout the live event, i.e., uninterrupted between and throughout the offerings of the respective items therein. Additionally or alternatively, an item catalogue server 132 may store a listing of known items, from among which hosts 112a may explore and select one or more items to be included for auction/direct purchase in live events. Still additionally or alternatively, a payment server 134 may store and process payment information relating to hosts 112a and/or guests 112b who are to acquire items via the live events described herein. Although each of the event server 124, image/video server 128, item catalogue server 132, and payment server 134 are described in singular herein, it should be understood that each of the servers 124, 128, 132, and 134 may respectively comprise one or more server devices, with functions thereof being distributed among the one or more servers.

The event server 124 may include an intelligent bundling module 136 which may implement techniques of this disclosure to identify bundles for items associated with a live event. For example, the intelligent bundling module 136 may monitor communications indicating assignment of items from host(s) 112a to guests 112b over the course of live events, and identify a plurality of items awarded to any same one of the guests 112b. Based upon item information (e.g., identifying the item itself, its size, weight, etc.), shipping information (e.g., carrier rates), and/or other constraints discussed in this disclosure, the intelligent bundling module 136 may determine shipping schemas including any two or more items to be bundled together under a same shipping label/package to achieve benefits described herein. Additionally, the intelligent bundling module 136 may perform additional actions to facilitate shipping, e.g., by generating and/or distributing shipping labels to the host 112a (e.g., at host device 110a), and/or by communicating with one or more carriers (e.g., to determine or update carrier fee structures, and/or to otherwise arrange, verify, or track shipping).

In any case, the intelligent bundling module 136 may be implemented in the computing environment 100 as non-transitory instructions stored at one or more computer memories, where the instructions, when executed via one or more computer devices (e.g., the event server 124 i.e., one or more servers), cause the one or more computer devices to perform actions attributed to the intelligent bundling module. Moreover, although the intelligent bundling module 136 is depicted in FIG. 1 as being implemented at the event server 124, it should be appreciated that at least portions of the intelligent bundling module 136 (e.g., at least some actions thereof) may be implemented at the host device 110a, e.g., as part of the host application 114. For example, the host application 114 may access information associated with live events from the event server 124 (e.g., identifying items to be distributed to respective guests), and may determine item bundles locally at the host device 110a. Additionally, or alternatively, the host 112a using the host application 114 may define custom shipping profiles and/or other constraints for use of intelligent bundling techniques (particularly, with respect to live events and shipments associated with the host 112a). Still additionally or alternatively, the host application 114 may be configured to execute various other user interfaces associated with viewing and configuring item bundles (e.g., including graphical user interfaces (GUIs) described herein), locally and/or based upon communications with the event server 124 and/or other servers in the computing environment 100.

Arrows in FIG. 1 represent signal communications exchanged among the elements of the computing environment 100 (e.g., including publish/subscribe communications). Elements of the computing environment 100 may communicate via any suitable one or more communications networks (e.g., the Internet, a wired or wireless local area network (LAN), etc.). Elements of the computing environment 100 may communicate of via any suitable one or more communication protocols, including for example a mobile cellular communications protocol (e.g., CDMA, GSM, EV-DO, LTE, IP, etc.), one or more IEEE 802.11 protocols (e.g., Wi-Fi), Bluetooth, and/or other suitable protocols in accordance with the computing capabilities of respective elements of the computing environment 100.

Generally, each of the image/video server 128, the item catalogue server 132, and the payment servers 134 may respectively comprise one or more processors and one or more non-transitory memories storing computer executable instructions that, when executed by the one or more processors, cause the server(s) to perform actions described herein. Although arrows in FIG. 1 connect the client computing devices 110a and 110b to the servers 128, 132, and 134 by way of the one or more event servers 124, it should be noted that in some embodiments, the server(s) 128, 132, and/or 134 may exchange communications directly with the client computing devices 110a and 110b. Furthermore, although the servers 124, 128, 132, and 134 are depicted in FIG. 1 as separate elements, it should be understood that functions of the servers 124, 128, 132 and 134 may be combined in various manners, in some embodiments. For example, in some embodiments, the event server 124 is configured to also perform at least some of the functions of the image/video server 128, the item catalogue server 132, and/or the payment server 134.

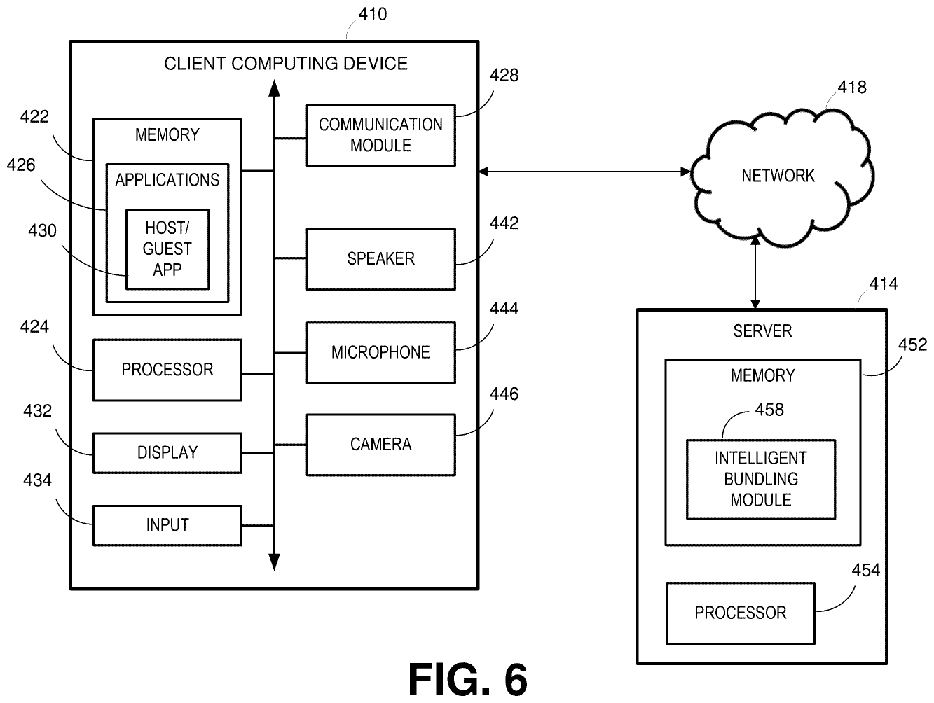

Subsequent portions of the present disclosure will include discussion of graphical user interfaces (GUIs) and other user-facing functionalities. In various embodiments, these functionalities may be implemented by suitable components of the computing environment 100 described above. Where interactive GUIs at a client computing device are described, interactions with the interactive GUIs may occur, for example, via touchscreen interactions, voice commands, and/or other suitable forms of user input at a host device(s) 110a and/or guest device(s) 110b, e.g., via components thereof that will be described for example with respect to FIG. 6. Described logic, communications, and functionalities may be implemented by way of the event server 124 and/or other servers of FIG. 1 which are in communication with the devices 110a and 110b.

### Example Shipping Schemas Based Upon Carrier Cost Structures

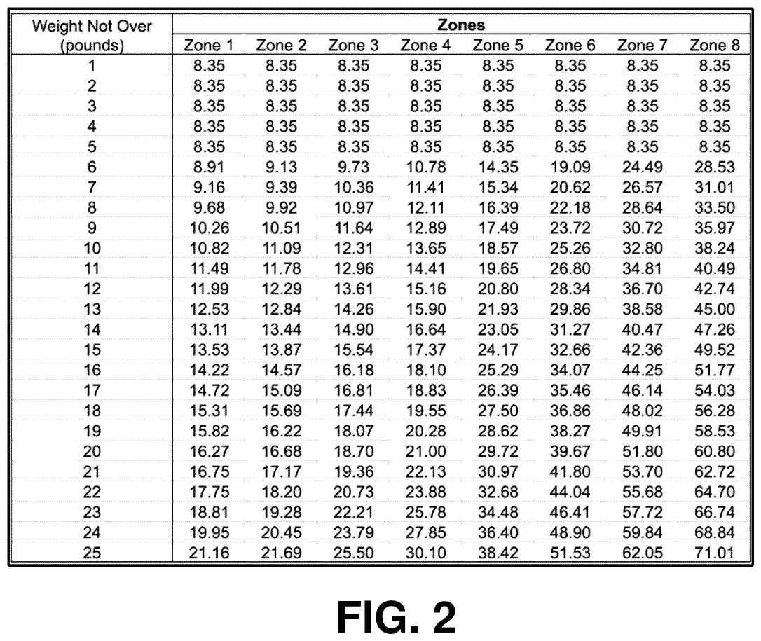

To demonstrate problems and solutions envisioned by the present disclosure, FIG. 2 depicts a chart of carrier fees as a function of weight and zone for packages between one and seventy pounds sent via USPS Priority Mail®, one example carrier service offered by USPS® shipping packages domestically between one and three business days. Although USPS Priority Mail® is used as an example herein, challenges and solutions described in this disclosure will apply similarly to other carriers, services, and geographical locations.

As observed from FIG. 2, costs of shipping with USPS Priority Mail® (in U.S. dollars) generally increase with corresponding increases to total weight of the shipped item(s) (including packaging). Shipping costs also vary based upon the “zone” of the shipment, which is based upon the distance between the origin and destination zip codes (e.g., Zone 1 for shipments less than 50 miles, Zone 8 is for shipments over 1800 miles, and the remaining zones for increasing distance intervals in between). An exception to the variation in price is that shipments not over five pounds total incur a same rate, regardless of distance from origin to destination.

Intelligent bundling techniques of the present disclosure emerge from the observation that one may find savings in shipping costs for multiple items by either (1) combining or “bundling” two or more items under a same shipping label/package, where the items might otherwise have been sent individually via separate shipping labels/packages, or (2) separating or “unbundling” two or more items that might have otherwise been shipped together.

To demonstrate the potential value of bundling items, one may consider a first scenario involving shipping of a single, large figurine from a seller to a recipient upon the conclusion of a live event. The total weight of a shipment containing the figurine might, for example, be approximately two pounds. However, a significant portion of the weight is comprised of the packaging. Thus, if a second identical (or similarly-sized) figurine were bundled in a same package as the first figurine, the total package weight may only increase for example by one and a half pounds because the same amount of packaging material need not be duplicated. Therefore, an “incremental weight” of the figurine may be characterized as approximately one and a half pounds. In view of the shipping chart of FIG. 2, intelligent bundling techniques of the present disclosure may determine that shipping two even three such figurines under (any zone classification) would incur the same shipping cost as one such figurine, due to the total weight being no greater than five pounds. Accordingly, the intelligent bundling techniques may identify the two or three figurines to be bundled under a same shipping label and package, when such figurines are directed to a same recipient upon conclusion of a live event.

Still referring to FIG. 2, to consider a second, different scenario, one may consider a shipment of two items to a recipient, where each item weighs approximately four pounds. Shipping the items together would result at least an eight-pound bundle, and likely in fact more than eight pounds total to accommodate the combined packaging for the two items (e.g., likely closer to nine or ten pounds). Shipping the items separately, on the other hand, would produce two shipments of likely between four and five pounds each (including respective packaging for each shipment). In view of the chart of FIG. 2, if the locations of the seller and recipient are such that the shipments would be one of Zone 5, 6, 7, or 8, the most cost-efficient practice may be to ship each item separately at the cost of $8.35 for each shipment ($16.70 total), rather than shipping as a bundle which would incur a higher cost. Moreover, it may be observed that breaking the four-pound items into separate shipments provides the opportunity to an add additional, small item(s) to each shipment without exceeding five pounds. In this circumstance, systems and methods herein may notify a recipient may of the opportunity to purchase additional small items (e.g., trading cards, comic books, etc.) without incurring additional shipping costs. Additionally or alternatively, a recipient may be gifted additional items at no item cost (e.g., as promotions) when such items do not add additional shipping costs.

Thus, from the cost structure outlined above, it can be observed that the lowest-cost schema for shipping of any particular group of items is dependent upon the cost structure of the carrier/service, and also upon the single-item (“base”) shipping weights and/or incremental shipping weights of any items being considered for inclusion in a bundle. Objectives of the intelligent bundling techniques of this disclosure include (1) identifying the most cost-effective shipping structure for any given combination of items, (2) providing functionalities for the user to define shipping profiles for any given item to facilitate effective determination of bundles (e.g., based upon base shipping weights and/or incremental shipping weights defined by the user), and/or (3) identifying opportunities to provide additional items to a recipient (e.g., “gifting” an item) while adding little or no total shipping cost to a group of items as a whole (e.g., “gifting” an additional item(s) when the item(s) can be added to a bundle without increasing the shipping cost of the bundle). Moreover, the intelligent bundling techniques herein may provide transparency of costs to sellers and recipients, e.g., by providing clear and detailed breakdowns regarding costs associated with items and decisions to bundle items (and, in some cases, to not bundle items).

As mentioned previously, the challenges and solutions described herein are not limited any one particular carrier service such as the USPS Ground Advantage® service described above. Rather, the challenges and solutions herein apply various services, carriers, and geographical locations, depending on the exact policies and pricing structures of each. Thus, techniques of this disclosure may be applied similarly via other USPS® services, including for example USPS Priority Mail Express®, USPS First-Class Mail@, USPS Ground Advantage® etc. Additionally, or alternatively, techniques of this disclosure may be applied similarly to services of other domestic and/or international carriers (e.g., FedEx®, UPS®, etc.), particularly where shipping prices vary at least based upon item weight and/or size.

In some embodiments, the intelligent bundling techniques herein may impose certain limits upon which items are eligible to be bundled. For example, in some embodiments, items with a volumetric size greater than one cubic foot (e.g., for the item alone, or for the item when packaged) are exempted from inclusion in intelligent bundling. As another example, a seller may specifically mark any particular item as being exempted from inclusion in intelligent bundling (e.g., via settings in a shipping profile, to be discussed in subsequent sections of this disclosure). Such items may be shipped alone, with intelligent bundling techniques being applied only to any remaining items directed to a recipient. Moreover, in some embodiments, any particular item may be subject to a “maximum bundle size,” e.g., defining how many same items, similarly-categorized items (e.g., in a same category such as “trading card,” comic book, etc.) and/or different items can be bundled with the particular item.

### Item Shipping Profiles

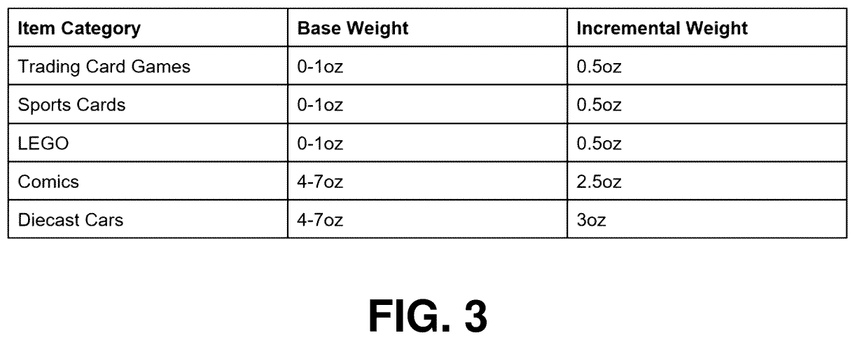

To help sellers and recipients understand the base and incremental shipping weights of items, the intelligent bundling techniques herein may provide shipping profiles establishing the typical shipping weights of certain categories of items. FIG. 3 depicts a chart of example shipping profiles of categories of items frequently distributed via the live events described herein, including cards from trading card games (TCG), sports cards, LEGO® items (e.g., rare/collectible LEGO® pieces), comic books (“comics”), and diecast cars.

For each item category, the chart of FIG. 3 lists a base shipping weight (“base weight”) referring to the expected total shipping weight of an item when shipped on its own (i.e., comprising the item and packaging, and not bundled with other items). For example, the base shipping weight of a single trading card or trading card pack is expected to be no greater than one ounce, and the base shipping weight of a comic book is expected to be between four and seven ounces. Although ranges of possible weights are listed in the chart of FIG. 3, more precise weight determinations may be obtained to further refine the intelligent bundling techniques herein. For example, in some embodiments, referring back to FIG. 1, the event server 124 may determine the base shipping weight of an item based upon stored historical information associated with same and/or similar items, and/or based upon stored item information (e.g., obtained via the item catalogue server 132). Additionally or alternatively, in embodiments, the seller may provide an indication of the precise base shipping weight of any particular item (e.g., based upon the seller's understanding of their preferred packaging and the weight thereof).

Also listed for each item category is an incremental shipping weight (“incremental weight”), referring to the expected weight added to an existing package when an item from the item category is added therein. For example, because shipping a second comic book with a first comic book would not be expected to add a substantial amount of packaging, the incremental shipping weight of the comic book is not much greater than the weight of the comic book itself (e.g., approximately two and a half ounces). A total weight may of the two comic books may be between six and a half and ten and nine and a half pounds. As another example, adding another trading card or card pack to a bundle already containing at least one (or two, three, four, etc.) cards/packs adds only an incremental shipping weight of half of an ounce. Incremental shipping weights may also be applicable across item categories, particularly where a smaller item is added into a bundle containing at least one larger item. For example, for a package or bundle already containing a diecast car with a base shipping weight between four and seven ounces, an additional trading card may still only add the incremental shipping weight of half of an ounce. On the other hand, if the scenario above is considered in reverse, where a diecast car is added to a bundle only containing trading cards, the addition of the diecast car may add a weight closer to its base shipping weight (rather than just its incremental shipping weight).

Based upon the above parameters, the intelligent bundling systems and methods of this disclosure may contemplate item bundles for any combination of items intended for a same recipient. For example, the systems and methods herein may track the progression of a live event to determine that a guest has purchased two comic books, one diecast car, one trading card pack and one sports card. Based upon the respective base shipping weights and/or incremental shipping weights of each item, along with the shipping cost structures of the selected carrier and service, the intelligent bundling techniques herein may determine the most cost-effective shipping schema for the plurality of items, which may for example include (1) combining all items in one bundle, (2) splitting the items between multiple bundles, and/or (3) shipping at least one item individually (i.e., not bundled). Moreover, based upon the determined schema, a recipient may be provided the opportunity to obtain additional items free of extra shipping charge (e.g., by notifying the recipient that they may add one or more items up to a certain weight without increasing the total shipping cost).

### Custom Shipping Profiles

Although the above shipping profiles may be provided to sellers and recipients of items to facilitate intelligent bundling of items frequently distributed via live events, it is envisioned that sellers may distribute other items not covered by the categories above, and/or may desire to override the base/incremental shipping weight settings for the categories described above when their own item weights and/or packaging weights do not match default settings. To that end, systems and methods of this disclosure enable sellers to define, save, and reuse “custom shipping profiles,” defining the weights and other parameters of item categories, based upon which inclusion/exclusion of items in bundles is determined.

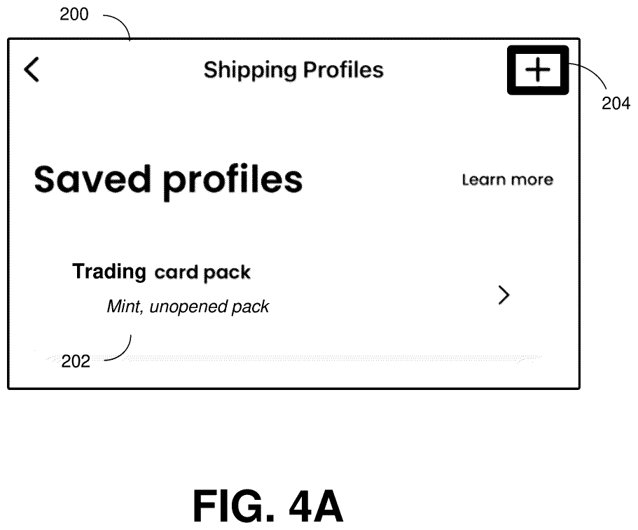

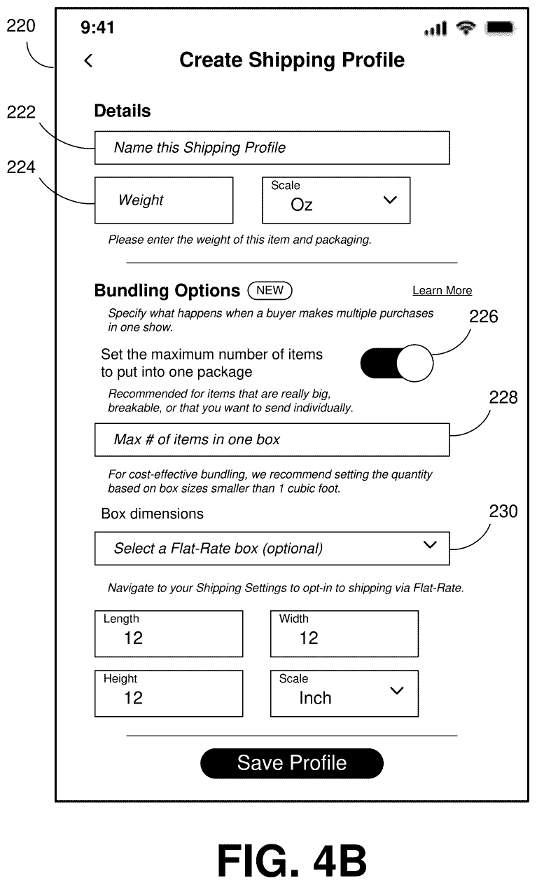

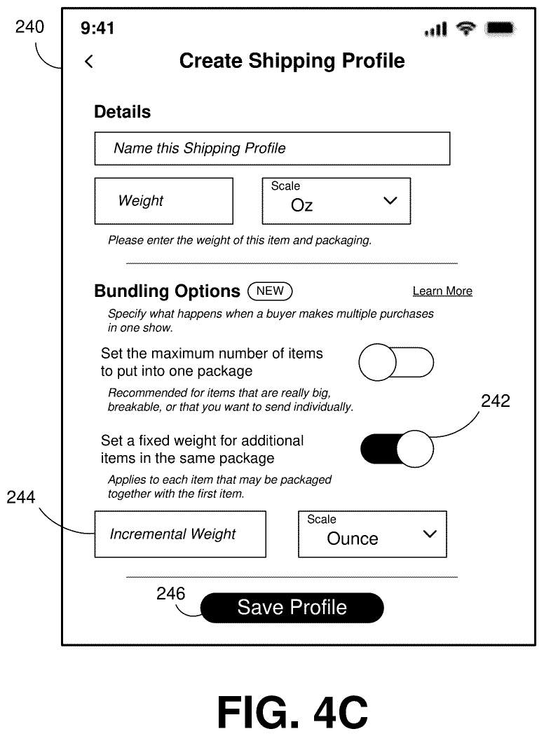

FIGS. 4A-4C depict example graphical user interfaces (GUIs) that may execute via one or more display units of a device of a user (e.g., at device 110a of host user 112a, and/or another suitable device in this disclosure) to define, modify, and/or use shipping profiles (e.g., custom shipping profiles) associated with items offered by a seller. The user may access the GUIs of FIGS. 4A-4C, for example, via a user profile page and/or settings page of the user, and/or via various other features of the live event platform described herein. Interactions described with respect to the GUIs of FIGS. 4A-4C may occur, for example, via touchscreen interactions, mouse/keyboard input, and/or another suitable form(s) of user interaction.

Beginning with FIG. 4A, a first example GUI 200 lists custom shipping profiles previously defined by the user. In this example, a GUI element 202 indicates a “trading card pack” custom shipping profile previously defined by the user. Further, the user may select an icon 204 (plus sign) to add a new shipping profile, for example as will be described with respect to FIGS. 4B and 4C.

Moving to FIG. 4B, another example GUI 220 allows a user to define a custom shipping profile for an item or category of item. A field 222 allows the user to name the custom shipping profile (e.g., the name as indicated in the GUI 200 of FIG. 4A). A field 224 allows the user to assign a base shipping weight and unit of measurement to items in the category. Furthermore, the user may use a toggle button 226 and a field 228 to indicate whether the custom shipping profile has a maximum number of the item that can be bundled (e.g., permitting the item to only be shipped by itself, with one other of the same and/or different items, with two other items, etc.).

Still lower in the GUI 220, additional fields enable the user to define default packaging dimensions for the item, e.g., a length, width, and height of a box containing the item, so as to reliably define the size and/or weight of the item when shipped. If the user chooses standardized or previously-defined packaging option in a field 230 (e.g., a USPS Priority Mail Flat Rate® envelope or box with known dimensions and, in some cases, predetermined cost structures), the GUI 220 may automatically populate fields below the field 230 with known dimensions for the packaging. Otherwise, the user may manually enter the dimensions in the additional fields. In some embodiments, the user may define multiple different sets of packaging dimensions, e.g., where the item may be shipped via any of two or more types of boxes, envelopes, etc. The intelligent bundling systems and methods herein may evaluate the multiple sets of packaging dimensions for any instance of shipping the item, to determine the most cost-effective shipping schema in view of other items directed to a same recipient (e.g., a particular one of the multiple sets of packaging dimensions may better allow for the item to be bundled together with an additional item(s) at a more advantageous cost).

Moving to FIG. 4C, another example GUI 240 is provided to allow the user to further define a custom shipping profile (e.g., in addition to the options provided in the GUI 220 of FIG. 4B). The GUI 240 of FIG. 4C may, in some embodiments, be an extension of the same GUI 220 from FIG. 4B (e.g., accessed by scrolling further down the GUI 220). In any event, via the GUI 240, the user may use a toggle button 242 and/or field 244 to define an incremental shipping weight for the item, i.e., the additional weight added to a package by way of a second, third, fourth, etc. of the same item.

By selecting a “save profile” option 246, the user may save the defined custom shipping profile to allow the user to assign the custom shipping profile to instances of items offered in live events (and/or in other contexts). Once an item is assigned to the custom shipping profile (or another shipping profile), the intelligent bundling systems and methods herein may assign instance instances of the item to bundles in accordance with the parameters of the custom shipping profile as described herein (e.g., based upon the defined base shipping weight, incremental shipping weight, maximum number of items, etc.).

### Intelligent Bundling Upon Conclusion of a Live Event

As previously described, the intelligent bundling systems and methods of this disclosure may track the assignments of items to guests over the course of a live event. Upon conclusion of a live event, systems and methods of this disclosure may provide the host (e.g., host 112a from FIG. 1) with information regarding outcomes of the intelligent bundling to facilitate shipping.

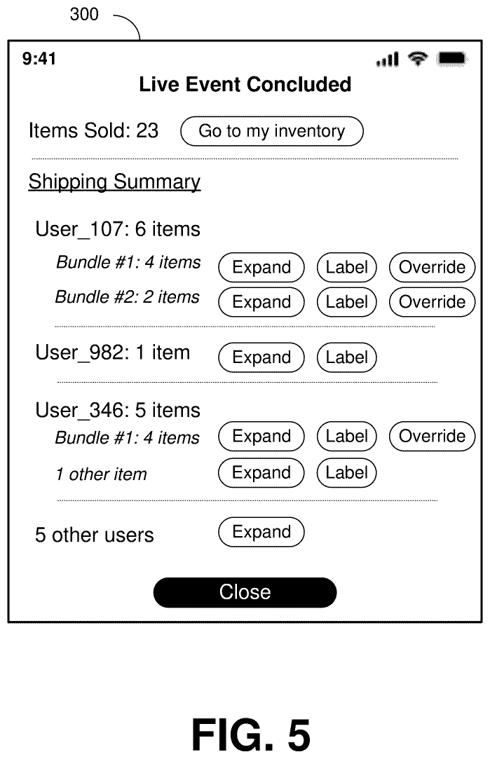

As depicted in FIG. 5, for example, a GUI 300 may execute at a device of the host (e.g., host device 110a of FIG. 1) to identify intelligent bundles and allow the host to proceed to shipping. As shown in the GUI 300, a shipping summary may indicate respective users who purchased one or more items over the course of the live event (e.g., via auction, direct purchase, giveaway, etc.). Where bundles have been identified for shipping, the GUI 300 indicates the respective bundles and number of items contained therein. An “expand” option allows the host to view full list of items in the bundle. The host may select a “label” option to obtain a shipping label for the indicated item or bundle of items, e.g., via email, printing, and/or other means. If the host does not wish to proceed with the bundle as determined, for whatever reason, the host may select an “override” option to cancel or modify the identified bundle (e.g., to instead ship each item individually, or to otherwise modify the distribution of items among one or more packages).

In various embodiments, the GUI 300 may display still additional information regarding the determined bundle(s), including for example (1) the determined or estimated shipping cost of any particular item and/or bundle, and/or (2) the determined or estimated savings incurred through bundling a plurality of items (e.g., as compared to shipping each item individually).

### Example Client Computing Device and Server

FIG. 6 depicts a block diagram of example components of a client computing device 410 and a server 414 communicating over a network 418, in accordance with embodiments of the systems and methods described herein. The client computing device 410 may correspond, for example, to any of the client computing devices of the present description (e.g., the host device 110a, the guest device 110b and/or 210, etc.). The server 414 may correspond, for example, to the event server 124, and/or to another one or more servers of the present description. The client computing device and/or server 414 may include additional, fewer, or alternate components to those described in this section, in various embodiments. Additionally, in some embodiments, the client computing device 410 may be substituted for another computing device(s), e.g., a desktop computer or laptop computer.

The client computing device 410 may include a memory 422, which may include one or more non-transitory memories (e.g., ROM) and/or one or more volatile memories (e.g., RAM). In particular, non-transitory portions of the memory 422 may store non-transitory, computer executable instructions that are executable by a processor 424 (i.e., one or more processors) to cause the client computing device 410 to perform actions described in this detailed description. Non-transitory portions of the memory 422 may include one or more applications 426. Each respective application 426 may include one or more sets of non-transitory computer executable instructions that, when executed by the processor 424, cause the client computing device 410 to perform operations associated with the respective application 426 (e.g., operations involving the processor 424, a communication module 428, and/or other components of the client computing device 410 discussed herein). The one or more applications may include a live event application 430 (“Host/Guest App”) usable to access live events as described herein. In embodiments, the live event application 430 may execute GUIs of the present disclosure, to generate and/or present intelligent bundles, and/or to perform other intelligent bundling techniques as described herein.

The client computing device 410 may include a display unit 432 (i.e., one or more display devices, such as a touch-enabled visual display (“touchscreen”) or other visual display). The client computing device may further include an input unit 434 (i.e., one or more user input devices, e.g., a touchscreen or touchpad, a keyboard, a mouse, etc.). In some embodiments, aspects of the display unit 432 and input unit 434 are integrated (e.g., as a touchscreen with both touch input and display capability). The display unit 432 and/or the input unit 434 may be physically included within the client computing device 410 (e.g., a fixedly installed touchscreen), or may be operatively coupled with the client computing device 410 by other means (e.g., a peripheral touch pad, mouse, keyboard, etc. connected to the client computing device 410 by wired and/or wireless means).

The client computing device 410 may include a speaker 442, a microphone 444, and/or a camera 446. In some embodiments, the client computing device 410 may include still other sensor components, e.g., a positioning unit (e.g., GPS), an accelerometer, a gyroscope, etc. The speaker 442, microphone 444, camera 446, and/or other sensor component(s) may be physically included within the client computing device 410 (e.g., a natively installed speaker, microphone, or camera), and/or may be operatively coupled with the client computing device 410 by other means (e.g., a peripheral camera, speaker, or microphone connected to the client computing device 410 by wired and/or wireless means).

Collectively, the display unit 432, input unit 434, speaker 442, microphone 444, camera 446, and/or other sensing component(s) may provide one or more user interfaces of the client computing device 410. For example, the display unit 432 may display/present one or more GUIs which may include interactive controls that the user of the client computing device 410 can activate via the input unit 434 to cause functionalities described herein to be performed (e.g., via a touchscreen touch or drag, a mouse click, a keyboard stroke, etc.). Additionally or alternatively, in some embodiments, similar user interfaces may be provided at least partially by the speaker 442, microphone 444, camera 446, and/or other sensing components of the client computing device 410 (e.g., an interactive audio interface, a gesture-based user interface, or a user interface responsive to physical movement of the client computing device 410). In some embodiments, a user of the live event application 430 at the client computing device 410 may configure device permissions defining components of the client computing device 410 the live event application 430 may use to provide GUIs, provide notifications, and/or perform other functionalities.

The server 414 (i.e., one or more servers, e.g., the event server 124 and/or other servers of FIG. 1) include a memory 452, which may include one or more non-transitory memories (e.g., ROM) and/or one or more volatile memories (e.g., RAM). In particular, non-transitory portions of the memory 452 may store non-transitory, computer executable instructions that are executable by a processor 454 (i.e., one or more processors) to cause the client computing device to perform actions described in this detailed description. Non-transitory portions of the memory 452 may include, for example, one or more applications containing non-transitory instructions for controlling logic and communications relating to live events, user profiles, device configuration information, analytics, etc. In particular, the memory 452 may include an intelligent bundling module 458, which may operate to generate intelligent bundles, store custom shipping profiles and/or other shipping profiles, and cause shipping bundle information to be presented to hosts and/or guests in accordance with techniques of this disclosure. The memory 452 may further store various other information, including for example information regarding user profiles, scheduled live events, and other functionalities involved in operation of the live events and other item selling contexts of this disclosure. The memory 452 may further include one or more APIs configured to control communications between the server 414 and the client computing device 410.

Although the intelligent bundling module in FIG. 6 is depicted as being provided in the memory 452 of the server 414, it is envisioned that in some embodiments, at least a portion of the intelligent bundling module 458 may additionally or alternatively be provided in the client computing device 410 (e.g., as a portion of the live event application 410, as another one of the applications 426, and/or elsewhere in the memory 422).

The network 418 may include any suitable one or more communications networks, e.g., the Internet, a wired or wireless local area network (LAN), etc. Communications over the network 418 may include communications according to any suitable one or more communications protocols, including for example a client cellular communications protocol (e.g., CDMA, GSM, EV-DO, LTE, IP, etc.), one or more IEEE 802.11 protocols (e.g., Wi-Fi), Bluetooth, and/or other suitable protocols in accordance with the computing capabilities of the client computing device 410 and/or the server 414.

Various additional or alternative computing elements may be envisioned, in various embodiments. In particular, it should be understood that the server 414 may communicate over the network 418 with many client computing devices 410, e.g., belonging to various combinations of hosts and/or guests.

### Example Computer-Implemented Method

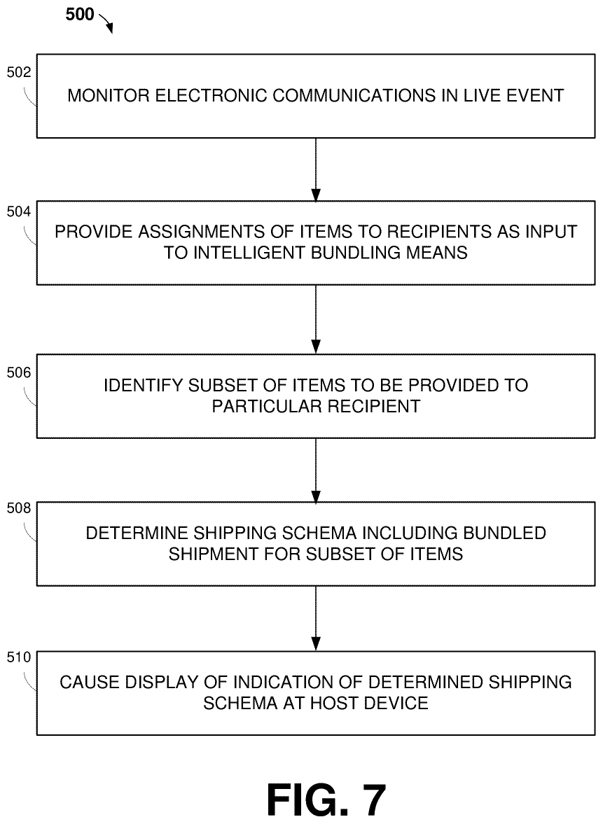

FIG. 7 depicts a block diagram of an example computer-implemented 500 associated with techniques of the foregoing portions of the present disclosure. The method 500 may be performed, for example, by a client computing device of a host user, e.g., via one or more processors a host device 110a, 210, and/or 410 as described in foregoing sections of the present description. Additionally, or alternatively, some or all actions of the method 500 may be performed via one or more processors of one or more servers, e.g., via the event server 124 and/or the server 414, and more particularly via the intelligent bundling module 136 and/or 458.

In embodiments, one or more memories of one or more computers (e.g., a host device, and/or one or more servers) may store non-transitory, computer executable instructions that, when executed via one or more processors of the one or more computers, cause the one or more computers to perform actions of the method 500. Furthermore, in some embodiments, one or more non-transitory computer readable media may be provided (e.g., a non-removable computer memory, a removable flash drive, etc.), the one or more non-transitory computer readable media storing instructions that, when executed by the one or more computers, cause the one or more computers to perform actions of the method 500. Actions of the method 500 may be combined and/or substituted with other actions described in the present description, in various embodiments.

The method 500 includes monitoring a plurality of communications in a live event (502, e.g., monitoring messages generated and/or transmitted in a publish/subscribe messaging framework associated with the live event). The live event may be associated with (i) respective offerings of a plurality of items by a host to a plurality of guests via a publish/subscribe messaging framework among a client computing device of the host and respective client computing devices of the plurality of guests, and in at least some cases (ii) real-time video stream from the client computing device of the host to each of the respective client computing devices of the plurality of guests. The real-time video stream may persist through the offerings of items, without interruption. The monitoring may include identifying indications of assignments of respective ones of the plurality of items to respective recipients from among the plurality of guests (e.g., as indicated by particular publish/subscribe messages, such as those explicitly identifying a purchaser or auction winner, or indicating a final bid before the conclusion of an auction).

The method 500 further includes causing the indications of the assignments of the respective ones of the plurality of items to be provided as inputs to an intelligent bundling means (504). The intelligent bundling means may be located at one or more servers and/or at the client computing device of the host. The intelligent bundling means may include, for example, the intelligent bundling module 136 from FIG. 1 which, as described in the foregoing sections of this disclosure, may be provided at least in part at the event server 124, and/or at least in part at the host device 110a (e.g., as a portion of the host application 114). Analogously, the intelligent bundling means may additionally or alternatively include the intelligent bundling module 458 from FIG. 6, at least a portion of which may be provided for example at the memory 452 of the server 414. Additionally or alternatively, though, at least a portion of the intelligent bundling module 458 may be provided at the client computing device 410 (e.g., as a portion of the live event application 430).

The method 500 still further includes, via the intelligent bundling means, identifying, from among the plurality of items, a subset comprising two or more items assigned to a particular recipient (506). This subset of items may be identified based upon the monitored electronic communications.

The method 500 still yet further includes, via the intelligent bundling means, determining a shipping schema for providing the subset of items from an origin (e.g., an address of the host or a fulfillment center) to a location of the particular recipient (508, e.g., the recipient's home or other shipping address). More particularly, the shipping schema may be determined based upon (i) item information associated with respective ones of the subset of items (e.g., base shipping weight and/or incremental shipping weights of respective items, maximum numbers of items of a certain type permitted to be bundled together, and/or default and/or custom shipping profiles for respective items), and/or (ii) shipping information associated with a carrier (e.g., cost structures for particular services, based upon weight, shipping distance, and/or other parameters). The determined shipping schema may include at least one bundled shipment, wherein a bundled shipment includes multiple items from among the identified subset of items to be shipped together (e.g., under one shipping label and/or package). The determined shipping schema may be one that minimizes a total shipping cost of the subset of items from the origin to the location of the recipient in view of the shipping information associated with the carrier.

The method 500 still further includes causing an indication of the determined shipping schema (e.g., indicating including the bundled shipment) to be presented to the host via a client computing device of the host (510, e.g., via one or more graphical user interfaces (GUIs), which may execute at the host client computing device alone and/or while in communication with one or more servers).

The method 500 may include additional actions, in some embodiments. For example, in some embodiments, the method 500 further includes causing a shipping label for the bundled shipment (and/or other portions of the determined shipping schema) to be generated and presented at the client computing device of the host. Additionally or alternatively, in some embodiments, the method 500 may include (1) determining a remaining allowable weight in the bundled shipment, such that an addition of a further one or more items to the bundled shipment does not increase a shipping cost of the bundled shipment when a combined weight of the further one or more items is less than or equal to the remaining allowable weight, and/or (2) causing an indication of one or more candidate items less than or equal to the remaining allowable weight to be presented at the client computing device of the host (e.g., as suggested items to purchase, or free items to include for the recipient as a promotion). Moreover, in some embodiments, the method 500 may include causing at least one of the candidate items to be added to the bundled shipment.

In various embodiments, the method 500 may include still additional, fewer, and/or alternate actions.

### Additional Considerations

Although the present disclosure describes intelligent bundling of items from live events, it should be appreciated that at least some of the techniques of the present disclosure may be applied additionally (or alternatively) in the context of other modes of distribution of items. For example, the intelligent bundling techniques herein may be applied to a plurality of items purchased by a user outside of a live event (e.g., through a central marketplace or via a seller's user profile). As another example, intelligent bundling techniques may be applied to items obtained via a combination of a live event and/or another context(s) (e.g., where a recipient purchases one, two, or three items via a live event, then later navigates to the seller's user profile and purchases another one, two, or three items).

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Unless a claim element is defined by reciting the word “means” and a function without the recital of any structure, it is not intended that the scope of any claim element be interpreted based upon the application of 35 U.S.C. § 112(f). The systems and methods described herein are directed to an improvement to computer functionality, and improve the functioning of conventional computers.

Throughout this specification, plural instances may implement components, operations, or structures described as a single instance. Although individual operations of one or more methods are depicted and described as separate operations, one or more of the individual operations may be performed concurrently, and nothing requires that the operations be performed in the order depicted. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Throughout the present disclosure, embodiments are described in which various elements are optional—present in some, but not all, embodiments of the system. Where such elements are depicted in the accompanying figures and, specifically, in figures depicting block diagrams, the optional elements are generally depicted in dotted lines to denote their optional nature.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for generating dynamic user experience applications through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims. The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited, and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

1. A computer-implemented method performed via one or more processors, the method comprising:
monitoring a plurality of electronic communications of a publish/subscribe messaging framework for a live event associated with (i) respective offerings of a plurality of items by a host to a plurality of guests via the publish/subscribe messaging framework among a host client computing device of the host and respective guest client computing devices of the plurality of guests, and (ii) a real-time video stream from the client computing device of the host to each of the respective client computing devices of the plurality of guests, the real-time video stream persisting through the offerings of the plurality of items,
wherein the monitored plurality of electronic communications of the publish/subscribe messaging framework comprise classes of messages defined by one or more servers and distributed among the host device and guest devices by the one or more servers based on subscription preferences of the guest devices,
and wherein the monitoring comprises identifying indications of assignments of respective ones of the plurality of items to respective recipients from among the plurality of guests, the indications being contained in at least a portion of the classes of messages;
causing the indications of the assignments of the respective ones of the plurality of items to be provided as inputs to an intelligent bundling means at one or more servers or at the client computing device of the host;
via the intelligent bundling means:
identifying, from among the plurality of items, a subset of items comprising two or more items assigned to a particular recipient, based upon the monitored electronic communications, and
determining a shipping schema for providing the subset of items from an origin to a location of the particular recipient, based upon (i) item information associated with respective ones of the subset of items, and (ii) shipping information associated with a carrier,
wherein the determined shipping schema comprises a bundled shipment of multiple items from among the subset of items, and wherein the determined shipping schema minimizes a total shipping cost of the subset of items from the origin to the location of the particular recipient in view of the shipping information associated with the carrier; and
causing an indication of the determined shipping schema to be presented to the host via the client computing device of the host.

2. The computer-implemented method of claim 1, wherein the item information comprises a base shipping weight and an incremental shipping weight of at least one item from among the subset of items.

3. The computer-implemented method of claim 1, wherein the item information comprises a custom shipping profile defined by the host for at least one item from among the subset of items.

4. The computer-implemented method of claim 1, wherein the item information defines, for at least one particular item from among the subset of items, a maximum number of instances the particular item permitted to be included in a bundled shipment.

5. The computer-implemented method of claim 1, wherein the one or more processors include one or more processors of the client computing device of the host.

6. The computer-implemented method of claim 1, further comprising causing a shipping label for the bundled shipment to be generated and presented at the client computing device of the host.

7. The computer-implemented method of claim 1, further comprising:
determining a remaining allowable weight in the bundled shipment, such that an addition of a further one or more items to the bundled shipment does not increase a shipping cost of the bundled shipment when a combined weight of the further one or more items is less than or equal to the remaining allowable weight; and
causing an indication of one or more candidate items less than or equal to the remaining allowable weight to be presented at the client computing device of the host.

8. One or more non-transitory computer readable media storing instructions that, when executed via one or more processors of one or more computers, cause the one or more computers to:
monitor a plurality of electronic communications of a publish/subscribe messaging framework for a live event associated with (i) respective offerings of a plurality of items by a host to a plurality of guests via the publish/subscribe messaging framework among a host client computing device of the host and respective guest client computing devices of the plurality of guests, and (ii) a real-time video stream from the client computing device of the host to each of the respective client computing devices of the plurality of guests, the real-time video stream persisting through the offerings of the plurality of items,
wherein the monitored plurality of electronic communications of the publish/subscribe messaging framework comprise classes of messages defined by one or more servers and distributed among the host device and guest devices by the one or more servers based on subscription preferences of the quest devices,
and wherein the monitoring comprises identifying indications of assignments of respective ones of the plurality of items to respective recipients from among the plurality of guests, the indications being contained in at least a portion of the classes of messages;
cause the indications of the assignments of the respective ones of the plurality of items to be provided as inputs to an intelligent bundling means at one or more servers or at the client computing device of the host;
via the intelligent bundling means:
identify, from among the plurality of items, a subset of items comprising two or more items assigned to a particular recipient, based upon the monitored electronic communications, and
determine a shipping schema for providing the subset of items from an origin to a location of the particular recipient, based upon (i) item information associated with respective ones of the subset of items, and (ii) shipping information associated with a carrier,
wherein the determined shipping schema comprises a bundled shipment of multiple items from among the subset of items, and wherein the determined shipping schema minimizes a total shipping cost of the subset of items from the origin to the location of the particular recipient in view of the shipping information associated with the carrier; and
cause an indication of the determined shipping schema to be presented to the host via the client computing device of the host.

9. The one or more non-transitory computer readable media of claim 8, wherein the item information comprises a base shipping weight and an incremental shipping weight of at least one item from among the subset of items.

10. The one or more non-transitory computer readable media of claim 8, wherein the item information comprises a custom shipping profile defined by the host for at least one item from among the subset of items.

11. The one or more non-transitory computer readable media of claim 8, wherein the item information defines, for at least one particular item from among the subset of items, a maximum number of instances the particular item permitted to be included in a bundled shipment.

12. The one or more non-transitory computer readable media of claim 8, wherein the one or more processors include one or more processors of the client computing device of the host.

13. The one or more non-transitory computer readable media of claim 8, wherein the instructions, when executed via the one or more processors, further cause the one or more computers to cause a shipping label for the bundled shipment to be generated and presented at the client computing device of the host.

14. The one or more non-transitory computer readable media of claim 8, wherein the instructions, when executed via the one or more processors, further cause the one or more computers to:
determine a remaining allowable weight in the bundled shipment, such that an addition of a further one or more items to the bundled shipment does not increase a shipping cost of the bundled shipment when a combined weight of the further one or more items is less than or equal to the remaining allowable weight; and
cause an indication of one or more candidate items less than or equal to the remaining allowable weight to be presented at the client computing device of the host.

15. A computing system comprising:
one or more processors; and
one or more memories storing non-transitory instructions that, when executed via the one or more processors, cause the computing system to:
monitor a plurality of electronic communications of a publish/subscribe messaging framework for a live event associated with (i) respective offerings of a plurality of items by a host to a plurality of guests via the publish/subscribe messaging framework among a host client computing device of the host and respective guest client computing devices of the plurality of guests, and (ii) a real-time video stream from the client computing device of the host to each of the respective client computing devices of the plurality of guests, the real-time video stream persisting through the offerings of the plurality of items,
wherein the monitored plurality of electronic communications of the publish/subscribe messaging framework comprise classes of messages defined by one or more servers and distributed among the host device and guest devices by the one or more servers based on subscription preferences of the quest devices,
and wherein the monitoring comprises identifying indications of assignments of respective ones of the plurality of items to respective recipients from among the plurality of guests, the indications being contained in at least a portion of the classes of messages;
cause the indications of the assignments of the respective ones of the plurality of items to be provided as inputs to an intelligent bundling means at one or more servers or at the client computing device of the host;
via the intelligent bundling means:
identify, from among the plurality of items, a subset of items comprising two or more items assigned to a particular recipient, based upon the monitored electronic communications, and
determine a shipping schema for providing the subset of items from an origin to a location of the particular recipient, based upon (i) item information associated with respective ones of the subset of items, and (ii) shipping information associated with a carrier,
wherein the determined shipping schema comprises a bundled shipment of multiple items from among the subset of items, and wherein the determined shipping schema minimizes a total shipping cost of the subset of items from the origin to the location of the particular recipient in view of the shipping information associated with the carrier; and
cause an indication of the determined shipping schema to be presented to the host via the client computing device of the host.

16. The computing system of claim 15, wherein the item information comprises a base shipping weight and an incremental shipping weight of at least one item from among the subset of items.

17. The computing system of claim 15, wherein the item information comprises a custom shipping profile defined by the host for at least one item from among the subset of items.

18. The computing system of claim 15, wherein the item information defines, for at least one particular item from among the subset of items, a maximum number of instances the particular item permitted to be included in a bundled shipment.

19. The computing system of claim 15, wherein the one or more processors include one or more processors of the client computing device of the host.

20. The computing system of claim 15, wherein the instructions, when executed via the one or more processors, further cause the computing system to:
determine a remaining allowable weight in the bundled shipment, such that an addition of a further one or more items to the bundled shipment does not increase a shipping cost of the bundled shipment when a combined weight of the further one or more items is less than or equal to the remaining allowable weight; and
cause an indication of one or more candidate items less than or equal to the remaining allowable weight to be presented at the client computing device of the host.
